(19) United States
(12) Patent Application Publication
(10) Pub. No.: US 2008/0000499 A1
(43) Pub. Date: Jan. 3, 2008

(54) System and method for cleaning a contactor device

(75) Inventors: James McFarlane, San Diego, CA (US); Enzo Bertaggia, Poway, CA (US); Craig Gadd, Lemon Grove, CA (US)

Correspondence Address: FOLEY AND LARDNER LLP;SUITE 500, 3000 K STREET NW, WASHINGTON, DC, 20007, US

(73) Assignee: Delta Design, Inc.

(21) Appl. No.: 11/639,429

(22) Filed: Dec. 15, 2006

Related U.S. Application Data
(60) Provisional application No. 60/817,532, filed on Jun. 30, 2006.

(51) Int. Cl. B08B 3/10; B08B 7/04; G06F 9/44

(52) U.S. Cl. 134/18; 134/57 R; 719/318

(57) ABSTRACT

A system and method for cleaning a contactor device is presented. The cleaning system includes an automated testing handler and a handler controller for controlling the operation of the handler and facilitating user interaction with the handler. The handler further includes a contactor having a plurality of pins for establishing an electrical connection with one or more input devices. The handler is configured to house one or more input devices and one or more surrogate cleaning devices. The surrogate cleaning devices are configured to clean the pins of the contactor. A pick and place mechanism positioned in the handler is configured to transport both the input devices and the surrogate cleaning devices to the contactor.

### CROSS-REFERENCE TO RELATED PATENT APPLICATION

This application claims priority from Provisional U.S. Application No. 60/817,532, filed Jun. 30, 2006, incorporated herein by reference in its entirety.

### BACKGROUND OF THE INVENTION

The following description of the background of the invention is provided simply as an aid in understanding the invention and is not admitted to describe or constitute prior art to the invention.

The present invention relates generally to the field of semiconductor device testing. Specifically, the present invention relates to a system and a method for cleaning a semiconductor device contactor in automated testing equipment (“ATE”).

ATE is used in the semiconductor industry to test semiconductor devices. Generally, the automated testing equipment is configured to receive a batch or “lot” of semiconductor devices for testing. The ATE conducts testing based on predetermined settings which are dependent upon the characteristics of each device input into the ATE for testing. During actual testing, various testing systems configured to manipulate the input device's operating conditions are applied to the input device and the result is recorded.

In general, to be tested, an input device is first connected to a contactor. The characteristics of the contactor used for testing affects the reproducibility of the test as well as the test yield. A poor contactor may cause invalid failures or test miscorrelations, which in turn can result in unwarranted machine downtimes, unexplained yield problems, and even customer returns.

The contactor includes a set of pins. These pins come into contact with the leads or solder balls of the input device during electrical testing. Contact elements are commonly composed of a beryllium-copper base metal with gold-plating on the surface. The profile of a contact element is critical to contact integrity and life prolongation.

During testing, each device must be inserted into the contactor for an electrical connection to the tester. Throughout the course of testing each device, pins on the contactor collect debris and other foreign substances. Foreign substances or debris cause the contactor to perform at less than optimal conditions. This may result in less than accurate testing results. Thus, the contactor pins must be cleaned at regular intervals. Currently, in most ATE the processing of equipment is halted in its entirety to clean the contactor pins. This method lengthens the time it takes to process and test a lot or batch of semiconductor devices. Accordingly, a system and method is needed to effectively clean contactors in ATE so that a lot of semiconductor devices may be processed efficiently.

### SUMMARY OF THE INVENTION

One embodiment of the invention relates to a system for cleaning a contactor device, including an automated testing handler. The handler further comprises a contactor having a plurality of pins for establishing an electrical connection with one or more input devices. The handler is configured to house one or more input devices and one or more surrogate cleaning devices, wherein the surrogate cleaning devices are configured to clean the pins of the contactor. A pick and place mechanism is positioned in the handler and is configured to transport both the input devices and the surrogate cleaning devices to the contactor. The system also includes a handler controller for controlling the operation of the handler and facilitating user interaction with the handler.

According to another embodiment of the invention, a method for cleaning a contactor device in a handler includes providing one or more surrogate cleaning devices i housed in the handler, providing one or more input devices in the handler and determining whether the contactor requires cleaning. If the contactor requires cleaning, the method executes an auto cleaning cycle. If the contactor does not require cleaning, the method executes a device processing cycle.

According to still another embodiment of the invention, the execution of the auto cleaning cycle includes the steps of determining whether a surrogate cleaning device is available for cleaning the contactor and inserting the surrogate cleaning device into the contactor in order to clean the contactor.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a block diagram of a system for cleaning a contactor device according to one embodiment of the invention.

FIG. 2 is a screenshot of a graphical user interface for a system for cleaning a contactor device according to one embodiment of the invention.

FIG. 3 is a block diagram of an automated testing equipment handler according to one embodiment of the invention.

FIG. 4 is a diagram of a surrogate cleaning device according to one embodiment of the present invention.

FIG. 5 is a flowchart illustrating an initialization sequence for a method for cleaning a contactor device according to one embodiment of the invention.

FIG. 6 is a flowchart illustrating the loading sequence for a method for cleaning a contactor device according to one embodiment of the invention.

FIG. 7 is a flowchart illustrating an auto cleaning cycle sequence for a method for cleaning a contactor device according to one embodiment of the invention.

FIG. 8 is a photograph of pogo pins for a contactor before being cleaned according to one embodiment of the invention.

FIG. 9 is a photograph of pogo pins for a contactor after being cleaned according to one embodiment of the invention.

FIG. 10 is a flowchart illustrating a post-cleaning sequence according to one embodiment of the invention.

### DETAILED DESCRIPTION OF THE PREFERRED EMBODIMENTS

Embodiments of the present invention will be described below with reference to the accompanying drawings. It should be understood that the following description is intended to describe exemplary embodiments of the invention, and not to limit the invention.

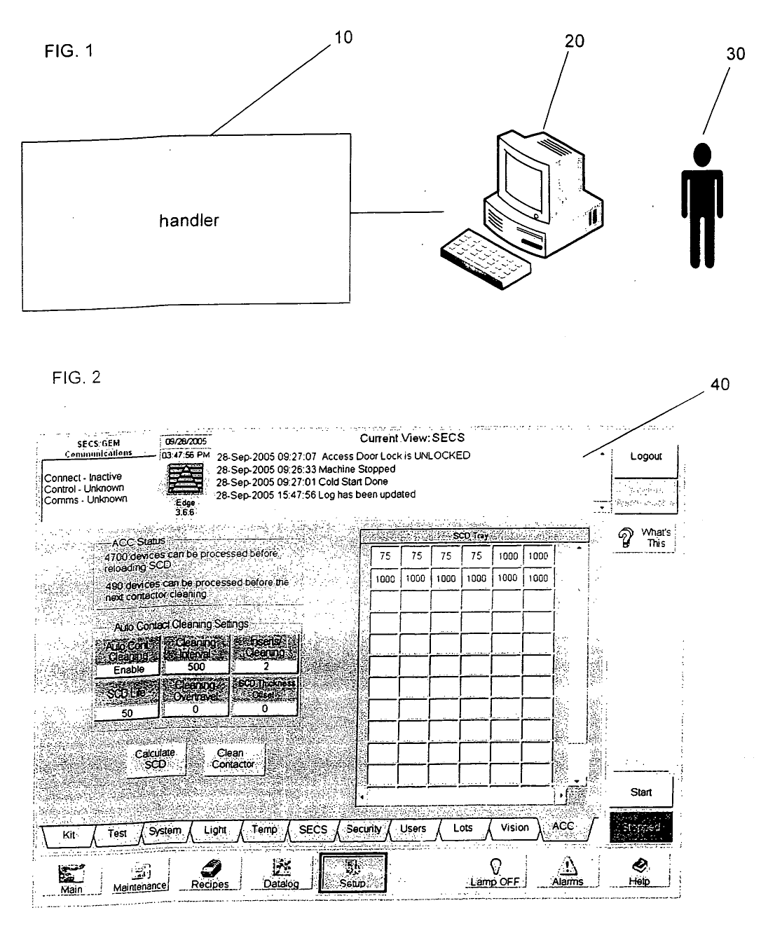

FIG. 1 shows a device cleaning system according to one embodiment of the invention. The device cleaning system includes a handler (ATE) 10 and a controller 20. According to one embodiment of the invention, the controller 20 is a personal computer, workstation or server operably connected to the handler 10. In another embodiment of the invention, the controller 20 may be integrated into the handler 10. The controller 20 includes a processor and memory configured to run software for operation of the device cleaning system. The controller 20 also allows a user 30 to input commands for execution by the handler 10. In addition, the controller 20 provides output to the user 30. According to one embodiment of the invention, a user 30 may input commands and view output through the use of a graphical user interface 40 implemented by the controller 20.

An exemplary embodiment of the graphical user interface is shown in FIG. 2. A user 30 may input commands and establish and change settings for the device cleaning system using the GUI 40. An example of the commands and settings a user 30 may establish using the GUI 40 will be discussed herein. These commands and settings can directly influence the handler's 10 operation and overall cleaning system performance.

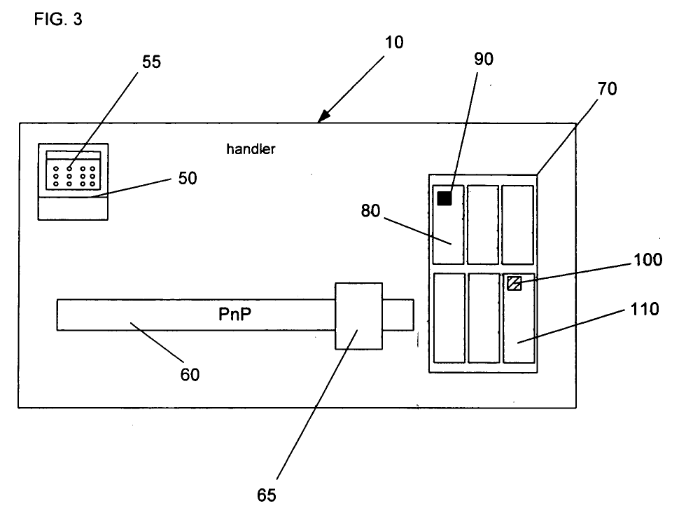

A block diagram of the handler 10 is shown in FIG. 3. The handler 30 includes at least one contactor 50, a pick and place mechanism 60 having a shuttle 65 and a bin 70 that may be populated with one or more JEDEC trays 80. The JEDEC trays include input devices 90 for testing. In addition, surrogate cleaning devices (SCD) 100 are housed in a standard JEDEC tray 110. Preferably, a unique bin 70 is also identified by the device cleaning system for housing the SCD JEDEC tray 110. The bin location is stored in a memory of controller 20 for the benefit of the device cleaning system software.

Input devices 90 are placed in physical contact with the contactor 50 to be tested. The contactor 50 establishes an electrical connection with the input devices 90 in order to test desired characteristics of the input devices 90. Generally, the configuration of the contactor 50 is dependent upon the input devices 90. The configuration of the contactor 50 impacts test results including test yields, and the ability to reproduce testing results.

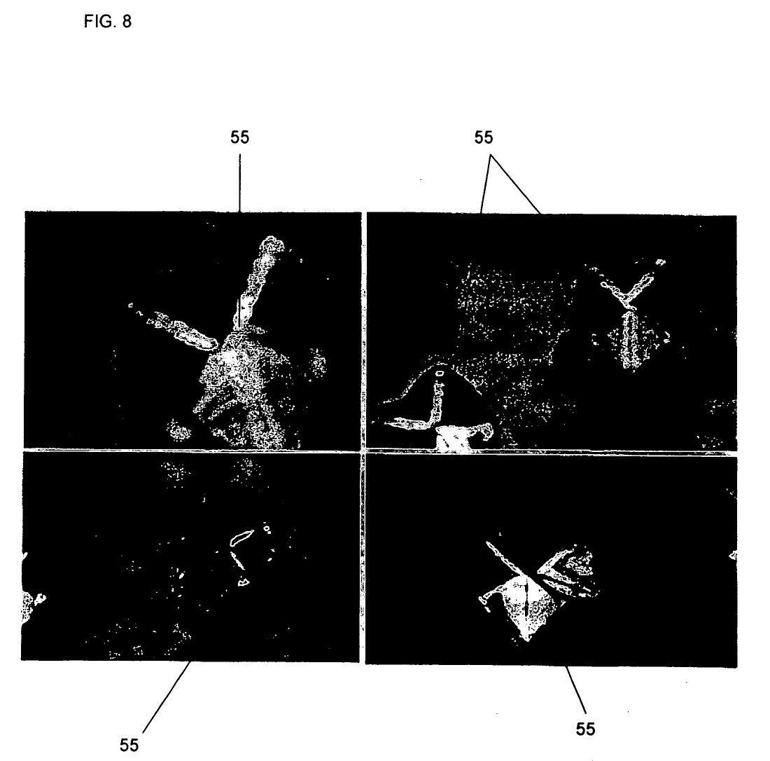

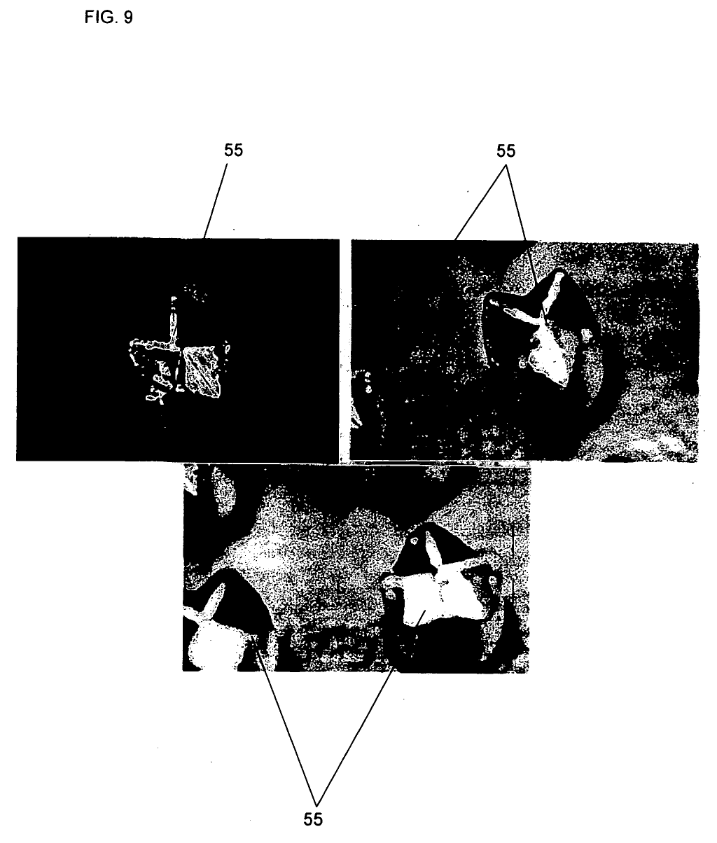

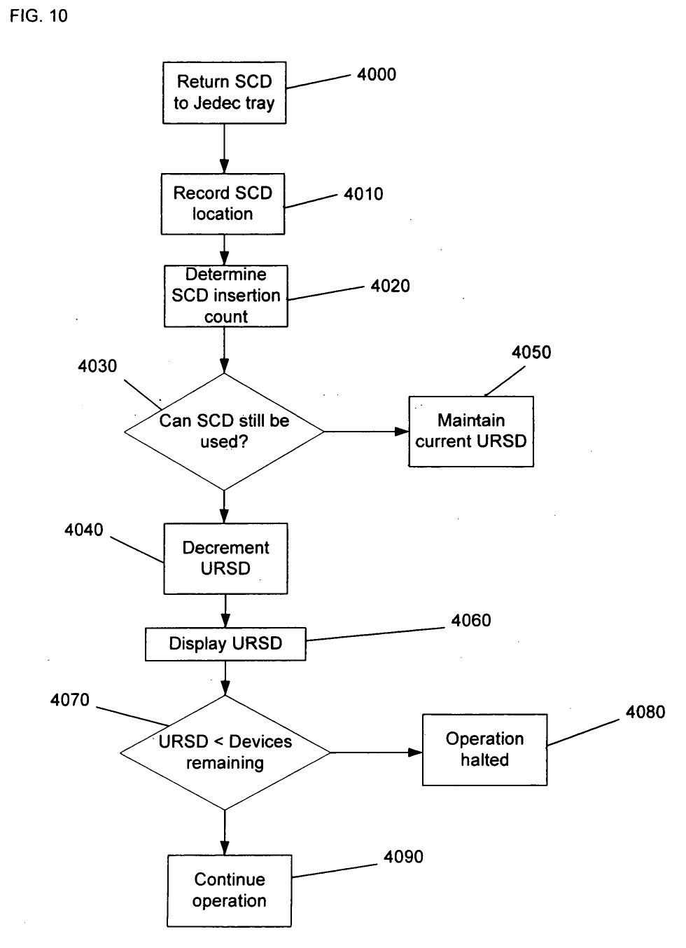

The contactor 50 has a set of contacts called pogo pins 55. The contacts 55 may also be referred to as contact fingers and/or contact elements. A pogo pin 55 is a type of nail affixed to the contactor to make contact with the input devices 90. Generally, pogo pins 55 and like elements are composed of beryllium-copper based metal with gold plating on the surface. An enlarged view of pogo pins 55 is shown in FIGS. 8 and 9. The pogo pins 55 are preferably relatively clean (free from debris) in order to insure quality operation of the device cleaning system. The use of SCDs 100 by the device cleaning system ensures cleanliness of the pogo pins 55 and thus efficient operation of the handler 10. Typically, for each group of contactors 50, there are several times that amount of distinct SCDs 100 used to clean the contactors 50.

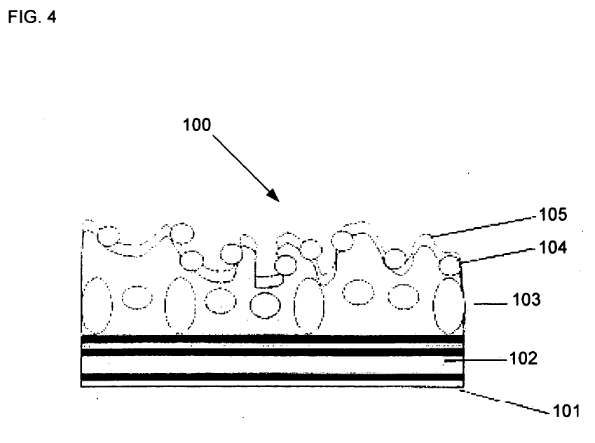

As shown in FIG. 4, according to one embodiment of the present invention, the SCD is composed of several layers. According to one embodiment of the invention, the SCD 100 is approximately 450 μm in thickness. Preferably the SCD 100 is within +/−0.010″ of the size of an input device 90. Generally, the layers that form the SCD 100 are composed of debris capturing materials. For example, the base layer is comprised of an adhesive 101. A PET film 102 is positioned on top of the adhesive 101. A polyurethane foam 103 rests on top of the PET film 102. The polyurethane foam 103 contains a resin 105 and an abrasive substance 104. These substances enable cleaning of the contactor 50, specifically the pogo pins 55.

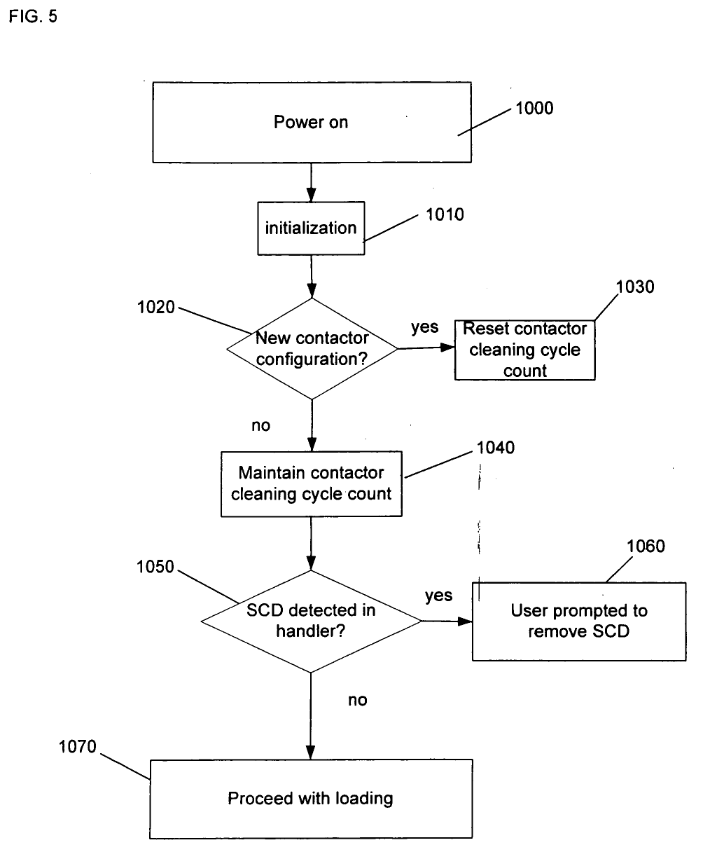

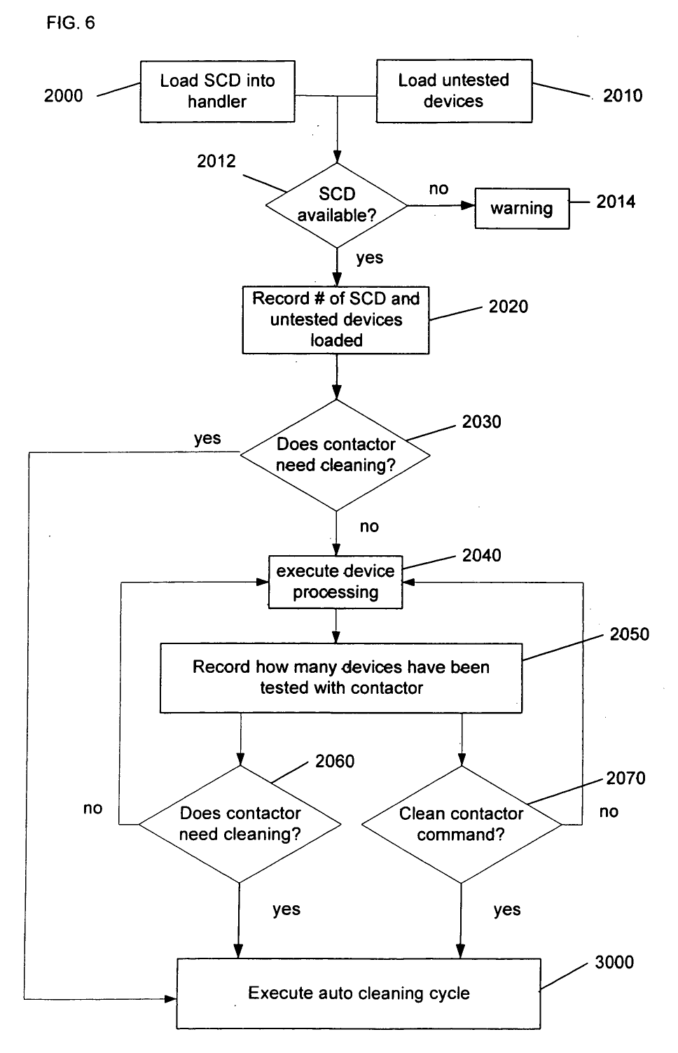

Operation of the system will now be described. FIG. 5 is a flowchart showing the power-on/initiation sequence for the device testing system according to one embodiment of the invention. First, the handler 10 is powered on (Step 1000). The controller 20 begins an initialization sequence for the handler 10 (Step 1010). According to one embodiment of the invention, one operation performed during the initialization sequence detects which devices are currently present in the handler 10 and possibly the current status of those devices. For example, the handler is capable of determining whether a new contactor 50 configuration is being used (Step 1020). If the contactor 50 configuration is new (meaning it was not used last time the handler 10 was powered on) the cleaning cycle count of the contactor 50 is reset (Step 1030).

The cleaning cycle count indicates how many times the contactor 50 has been used to test an input device 90. After a certain number of devices 90 have been tested the same contactor 50, the system determines that the contactor 50 should be cleaned to continue effective processing operations. The cleaning cycle count is preset in the device cleaning software at a default amount. However, the user 30 may change the cleaning cycle count via the GUI interface 40. Resetting the cleaning cycle count for the contactor 50 indicates that the current contactor 50 in use is clean and has not been used to test any input devices 50. In the alternative, if the handler 10 determines that the contactor 50 configuration is not new, then the contactor cleaning cycle count is retrieved from the system memory (Step 1040).

In addition, during the power on sequence the handler determines whether SCDs 100 are currently present (Step 1050). If SCDs 100 are present in the handler 10 during the power on, then the user 30 is prompted to remove the SCD 100 (Step 1060). The system requests removal of the SCDs 100 because there is no way to know how many of the SCD 100 are used (e.g., have already been used to clean parts) versus how many SCDs 100 are new. Preferably, because of the physical composition of the SCDs 100, the SCDs 100 are used to clean a contactor 50 only once. After one use, a SCD 100 is less effective at cleaning a second contactor 50. In the alternative, if SCDs 100 are not detected in the handler, the device testing system proceeds to its loading procedures (Step 1070).

The loading and processing procedures for the device testing system will now be described with reference to FIG. 6. As stated above, preferably a designated bin 70 is used to house the SCD JEDEC tray 110. Prior to loading, a user 30 may select a bin to house the SCD JEDEC tray 110. According to one embodiment of the invention, the SCD JEDEC tray 110 is keyed/notched so that only the SCD JEDEC 110 can be placed into the designated bin. Generally, as shown in FIG. 6, SCDs 100 are loaded into the handler 10 after power-on and initialization (Step 2000). However, according to another embodiment of the invention, SCDs 100 may be loaded in the middle of lot processing depending upon the number of input devices 90 used.

As further shown in FIG. 6, SCDs 100 and input devices 90 may be loaded into the handler 10 simultaneously (Steps 2000, 2010). A full or partial SCD JEDEC tray 110 may be loaded in a designated bin 70. Generally, after loading is complete, the doors of the handler 10 are closed. Upon closing of the handler door (not shown), the system runs a self-test. For example, according to one embodiment of the invention, the device cleaning system checks to see if SCDs 100 are available after closing the handler door (Step 2012). If SCDs 100 are available, the device cleaning system proceeds to Step 2020 as shown in FIG. 6. If the device cleaning system determines that there are no SCDs 100 present in the handler 10, then a warning message is displayed to the user 30 (Step 2014). Once the SCDs 100 and input devices 90 are placed in the handler 10, the device cleaning system records the number of SCDs 100 and input devices 90 (Step 2020). Upon receiving an indication that the input devices 90 are ready for processing, the device cleaning system determines whether the contactors 50 populating the handler 10 need cleaning (Step 2030). Whether or not a contactor 50 needs cleaning depends upon the contactor's 50 cleaning cycle count, which was described above. If the contactor 50 needs cleaning, then the auto cleaning cycle is initiated. If the contactor 50 does not need cleaning, then device processing 2040 is initiated.

In device processing 2040, the input devices 90 are tested using the contactors 50 populating the handler 10. During this process, the device cleaning system records the number of times each contactor 50 is used to test an input device, thus yielding a contactor 50 cleaning cycle count (Step 2050). As shown in FIG. 6, after the contactor cleaning cycle count is calculated, the device cleaning system again determines whether a contactor 50 needs cleaning (Step 2060). If the cleaning device system determines that the contactor 50 needs cleaning, then the auto cleaning cycle 3000 is initiated. If the contactor does not need to be cleaned, input device processing 2030 continues. According to one embodiment of the invention, in the alternative, a user 30 may input a clean contactor command 2070. Once the clean contactor command 2070 is received the auto cleaning cycle is initiated (Step 3000).

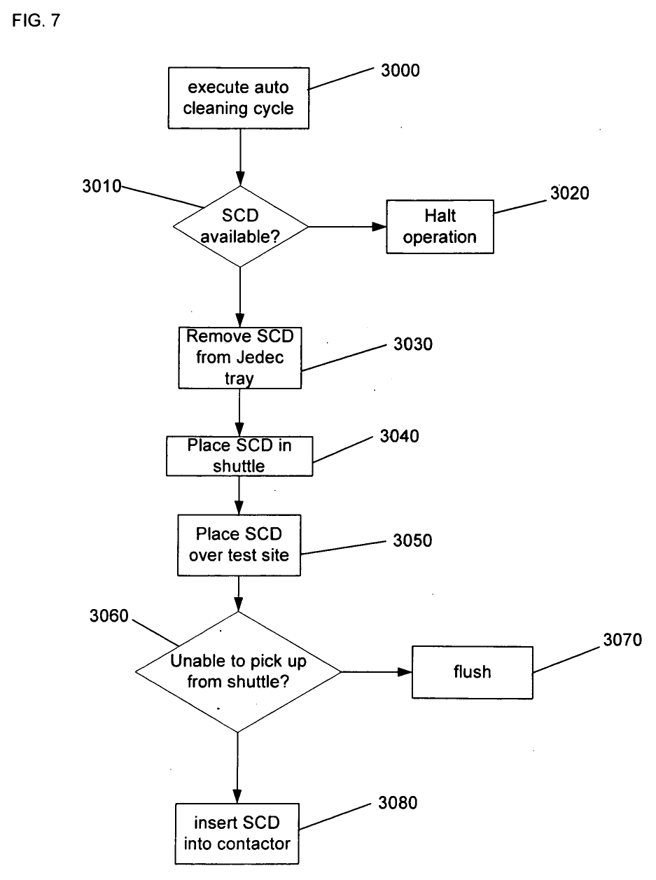

FIG. 7 illustrates an aspect of the auto cleaning cycle according to one embodiment of the invention. Generally, the auto cleaning cycle is implemented when the contactor cleaning cycle count has reached a testing threshold. In the alternative, the auto cleaning cycle may be initiated by a user 30. For example, a user 30 may execute a clean contactor command to initiate the auto cleaning cycle (Step 3000). After the initialization of the cleaning cycle, the device cleaning system determines if SCDs 100 are available to carryout cleaning (Step 3010). If SCDs 100 are not available, then the auto cleaning cycle operation is halted (Step 3020). If there are SCDs 100 available in the handler 10, then the auto cleaning cycle proceeds without halting. First, the device cleaning system activates the pick and place handler 60 in order to remove at least one SCD 100 from the SCD JEDEC tray 10 (Step 3030). Once removed, the SCDs 100 are placed into a shuttle 65 (Step 3040). The orientation and placement of the SCD 100 in the shuttle is dependent upon the configuration of the contactor 50 at a test site in the handler. For example, if the test site is configured in a 2×2 pattern then the orientation of the SCDs 100 in the shuttle 65 must also be 2×2.

The shuttle 65 transports the SCDs 100 to the test site in the proximity of the contactor 50 (Step 3050). Next, the SCDs 100 are removed from the shuttle via the pick and place handler 60. If the pick and place device 60 is unable to pick up the SCDs 100 (Step 3060) then the system implements a flush (Step 3070). If at any point, the handler 10 is unable to pickup an SCD 100 from the shuttle 65 or if an SCD 100 is dropped while a mechanism is moving, the entire lot of devices must be re-run because of SPC failure. In the event the SCD 100 can be picked up by the user 30 entering a retry command, a flush operation does not take place. According to another embodiment of the invention, the handler 10 includes a mechanism for determining whether the system is having difficulty picking up an SCD 100 or an input part 90.

However, if the pick and place mechanism is able to pick up the SCDs 100, each SCD 100 is plunged into a contactor in order to clean the pogo pins 55 of the contactor 50 (Step 3080). According to an alternative embodiment, the SCDs 100 are positioned near the test site and accordingly do not need to be transported via a shuttle to the test site. According to one embodiment of the invention, all contactors 50 that are enabled are cleaned at the same time. Generally, a SCD 100 is inserted into the contactor and then the device cleaning system waits a predetermined, user defined period of time (e.g., 100 ms) before retracting the SCD 100. This insertion step may be repeated a number of times based on the device testing settings. For example, the number of times an SCD 100 is inserted into a contactor 50 is dependent upon a variable set by the user 30 entitled “Insertions per Cleaning Cycle.” The user may set this variable using the GUI 40. During cleaning, the system displays a message to the user 30 indicating that contactor cleaning is underway. Once the SCD 100 has been inserted into the contactor 50 a predetermined number of times, the SCD 100 is returned to a JEDEC tray.

The SCD 100 effectively cleans and removes debris from the pogo pins 55 of the contactor 50. FIG. 8 shows multiple photographs of the pogo pins 55 of a contactor 50 covered in debris. The photograph was taken before cleaning. The debris may significantly affect the performance of the contactor 50 and thus the processing of multiple input devices 90. FIG. 9 shows multiple photographs of the same pogo pins 55 shown in FIG. 8 after being cleaned by the insertion of an SCD 100 as described above. As shown in FIG. 9, debris is no longer present on the pogo pins 55. Removal of debris in this manner maintains the performance of the contactor 50 during testing operations.

As stated above, once the SCD 100 has been inserted into the contactor 50 a predetermined amount of times, the SCD 100 is returned to a JEDEC tray (Step 4000). In addition, the physical location of the SCD 100 in a JEDEC tray once it has been returned is recorded and stored in controller memory (Step 4010). Upon the return of the SCD 100, the amount of times the SCD 100 was inserted into a contactor 50 is recorded and stored in controller memory (Step 4020). Based on the insertion count of the SCD 100, the device cleaning system determines whether the device can continue to use the SCD 100 (Step 4030). The SCD insertion count is a user defined threshold. If the SCD 100 insertion count is greater than the threshold, then the system decrements the value of a variable used to track the number of units remaining until SCD depletion (“URSD”) (Step 4040). In the alternative, if the SCD 100 insertion count is less than a threshold amount, then the URSD number remains the same (Step 4050). After either step 4040 or 4050, the value of the URSD is displayed to the user 30 (Step 4060). Further, after a URSD value is determined, the system determines whether that value is less than the number of untested input devices 90 remaining in the handler (Step 4070). In other words, the system determines whether there are enough SCDs 100 to test the remaining input devices 90. If not, the operation of the handler is halted and a message is displayed to the user 30 (Step 4080). If the system detects that there are enough SCDs to test the remaining input devices 90, then system operation continues normally (Step 4090).

As set forth in the embodiments disclosed above several advantages of the invention are realized. For example, the present invention facilitates the cleaning of contactor devices while carrying out input device processing operations such as testing. The system cleans the contactor after the contactor has been used to test a set number of input devices. Depending on the characteristics of the input devices and the nature of the testing, this number can be adjusted so that the contactor operates at optimal levels. Moreover the system and method allows for cleaning of the contactor without significantly interrupting input device processing. Thus, the system and method allow for efficient and high quality testing of semiconductor devices.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A system for cleaning a contactor device, comprising:
an automated testing handler, wherein the handler further comprises:
a contactor having a plurality of pins for establishing an electrical connection with one or more input devices;
one or more input devices;
one or more cleaning devices, wherein the cleaning devices are configured to clean the pins of the contactor;
a pick and place mechanism configured to transport both the input devices and the cleaning devices to the contactor; and
a handler controller for controlling the operation of the handler and facilitating user interaction with the handler.

2. The system as claimed in claim 1, wherein the handler controller is a personal computer operably connected to the handler.

3. The system as claimed in claim 1, wherein the handler controller is integrated into the housing of the handler.

4. The system as claimed in claim 1, wherein the handler controller allows a user to input information and commands to the handler via a graphical user interface.

5. The system as claimed in claim 1, wherein the pick and place mechanism further comprises a shuttle configured to physically remove an input device or cleaning device from a tray and place the input device or cleaning device on the contactor.

6. The system as claimed in claim 1, wherein the trays are standard JEDEC trays.

7. A method for cleaning a contactor device in a handler, comprising the steps of:
providing one or more cleaning devices in the handler;
providing one or more input devices in the handler;
determining whether the contactor requires cleaning;
if the contactor requires cleaning, executing a cleaning cycle using one or more of the cleaning devices; and
if the contactor does not require cleaning, executing a device processing cycle.

8. A method for cleaning a contactor device in a handler according to claim 7, wherein the determining whether the contactor requires cleaning step further comprises:
determining how many input devices have been tested by the contactor device to obtain a contactor cleaning cycle count; and
determining whether the contactor cleaning cycle count is greater than a testing threshold.

9. A method for cleaning a contactor device in a handler according to claim 7, wherein the executing a device processing cycle step further comprises:
conducting testing on the input devices using the contactor;
recording how many input devices have been tested with the contactor;
determining whether the contactor requires cleaning; and
if the contactor requires cleaning, executing the auto cleaning cycle.

10. A method for cleaning a contactor device in a handler according to claim 7, wherein the executing an auto cleaning cycle step further comprises:
determining whether a cleaning device is available for cleaning the contactor;
removing the cleaning device the from the first tray; and
inserting the cleaning device into the contactor.

11. A method for cleaning a contactor device in a handler according to claim 10, wherein the cleaning device is retracted from the contactor after a predetermined amount of time elapses.

12. A method for cleaning a contactor device in a handler according to claim 10, wherein the executing an auto cleaning cycle step further comprises:
after cleaning the contactor, returning the contactor device to a tray;
recording the exact position of the cleaning device in the tray;
recording the number of times the cleaning device has been inserted into the contactor;
determining whether the cleaning device can still be used to clean the contactor; and
determining the units remaining until the cleaning devices are depleted.

13. A method for cleaning a contactor device in a handler according to claim 10, wherein the removing step further comprises:
placing a cleaning device in a shuttle of a pick and place device;
determining if the shuttle is unable to pick up the cleaning device; and
if the shuttle is unable to pick up the cleaning device, executing a flushing operation.

14. A method for cleaning a contactor device in a handler according to claim 10, wherein if the cleaning device is not available, a halt operation is initiated.
